(19) United States
(12) Patent Application Publication
(10) Pub. No.: US 2004/0062981 A1
(43) Pub. Date: Apr. 1, 2004

(54) Electrolyte matrix, especially for a molten carbonate fuel cell, and a method for producing the same

(76) Inventor: Mike Friedrich, St. Wolfgang (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/416,727

(22) PCT Filed: Nov. 13, 2001
(86) PCT No.: PCT/EP01/13092

(30) Foreign Application Priority Data
Nov. 15, 2000 (DE) 100 56 538.7
Dec. 2, 2000 (DE) 100 60 052.2

(51) Int. Cl. H01M 8/14; C04B 35/10; C04B 35/64

(52) U.S. Cl. 429/46; 264/618

(57) ABSTRACT

A method for producing an electrolyte matrix for a fuel cell, especially a molten carbonate fuel cell, the method comprising mixing components which comprises a dispersant, at least one lithium compound, aluminum oxide, and zirconium carbide, to provide a matrix material. Fuel cells produced with the disclosed electrolyte matrix do not form cracks due to the differences in thermal expansion coefficients between the matrix and the surrounding metallic components, and thus have improved performance and service life. Also disclosed are the electrolyte, the matrix, and the fuel cell so produced.

The invention relates to an electrolyte matrix, especially for a molten carbonate fuel cell, and a method for producing the same.

Usually, for producing electric energy by means of fuel cells, a larger number of fuel cells is disposed in a stack. Each of the fuel cells has an anode, a cathode and an electrolyte matrix, which is disposed between the electrodes. The individual fuel cells are separated from one another by bipolar plates and contacted electrically, and, at the anodes and the cathodes, current collectors are provided for electrically contacting the electrodes, and the fuel gas and the cathode gas are channeled to and from the electrodes. In each case, sealing elements are provided in the edge region of the anode, cathode and electrolyte matrix and provide a lateral seal for the fuel cells and, with that, for the fuel cell stack to prevent leakage of anode and cathode material and of the electrolyte material of the matrix. The molten electrolyte, fixed in the porous matrix, typically consists of binary alkali carbonate melts Li₂CO₃/K₂CO₃ or Li₂CO₃/Na₂CO₃ or of ternary melts Li₂CO₃/Na₂CO₃/K₂CO₃. In operation, molten carbonate fuel cells typically reach operating temperatures of 600° to 650° C.

During the operation of molten carbonate fuel cells, one difficulty is that the difference between the thermal coefficients of expansion of the electrolyte matrix and those of the surrounding metallic components of the fuel cell, especially of the lateral sealing elements, leads to thermally induced tensile stresses, which may result in crack formations in the matrix, especially while the fuel cell is being started up. As a result, the desired performance and service life of the fuel cells may not be reached.

Fuel cells of this type are known, for example, from U.S. Pat. Nos. 5,997,794, 5,869,203, 6,037,976 and 5,880,673 and from the DE 4,030,945 A1. For example, crystalline aluminum and lithium carbonate are added to alpha lithium aluminate in U.S. Pat. No. 5,869,203 in order to increase the strength of the electrolyte matrix aluminum oxide and, later on, lithium aluminate being formed while the fuel cell is being started up. This leads to an increase in the strength of the electrolyte matrix, which is associated with a slight increase in length. However, this does not yet solve the problem described above.

It is an object of the invention to provide an electrolyte matrix, especially one for a molten carbonate fuel cell, for which the matrix does not form cracks due to the different thermal coefficients of expansion between the matrix and of the metallic components surrounding it. Furthermore, a method for producing such an electrolyte matrix is also disclosed.

An electrolyte matrix is created by the invention. Pursuant to the invention, provisions are made so that the electrolyte matrix consists of a matrix material, the volume of which does not undergo an increase in volume as the fuel cell is being started up. An electrolyte matrix with this property can be used advantageously for molten carbonate fuel cells and also for other types of fuel cells.

It is an advantage of the inventive electrolyte matrix that, due to the increase in volume as the fuel cell is being started up, different thermal coefficients of expansion between metallic components of the fuel cell and the electrolyte matrix are compensated for. Accordingly, the development of cracks in the matrix can be prevented. A further advantage is that, due to the increase in volume of the electrolyte matrix, there is an increase in the contacting pressure between the electrolyte matrix and the electrodes as well as their current collectors, which leads to improved contacting and, consequently, a higher cell output.

According to a preferred embodiment of the invention, provisions are made so that the matrix material contains one or more lithium compounds, aluminum oxide and one or more zirconium compounds. One advantage of this is a clear reduction in the raw material costs for the electrolyte matrix and, with that, a reduction in the costs of producing the fuel cell.

Advantageously, the matrix material contains lithium acetate and/or lithium carbonate and/or lithium aluminate.

Furthermore, the matrix material preferably contains zirconium carbide.

In accordance with a preferred embodiment of the invention, provisions are made so that the matrix material furthermore contains secondary particles, the size of which is on a nano scale.

Preferably, as secondary, nano-scale particles, the matrix material contains one or more of ZrO₂, SiO₂, Al₂O₃, and/or TiO₂.

Preferably, when the molten carbonate fuel cell is being started up, the matrix material forms an aluminate, especially lithium aluminate, an oxide, especially zirconium dioxide and/or a zirconate, especially lithium zirconate.

Preferably, the formation of the matrix material takes place as the fuel cell is being started up, the material experiencing an increase in volume.

Preferably, provisions are made so that, as the fuel cell is being started up, the increase in volume of the matrix material is approximately the same as, or is larger than, the thermal expansion of other fuel cell components associated with the electrolyte matrix.

Preferably, after the fuel cell is started up, the electrolyte matrix has an open porosity of 30 to 70% and preferably of 40 to 60%.

Furthermore, it is of advantage if, after the fuel cell has been started up, the electrolyte matrix has an average pore diameter of less than 0.4 μm and preferably of less than 0.2 μm.

According to an embodiment of the invention, provisions are made so that the electrolyte matrix is produced as a single-layer matrix.

According to a different advantageous embodiment of the invention, provisions are made so that the electrolyte matrix is produced as a multilayer matrix.

According to a further advantageous development, provisions are made so that the electrolyte matrix is produced as a multilayer matrix with several, similar layers.

Furthermore, a method for producing an electrolyte matrix is provided by the invention. Pursuant to the invention, provisions are made so that the electrolyte matrix is produced from a matrix material containing one or more lithium compounds, aluminum oxide and one or more zirconium compounds.

Preferably, lithium acetate and/or lithium carbonate and/or lithium aluminate are used as matrix material for the method.

Furthermore, the use of zirconium carbide as a component of the matrix material is of advantage.

According to a preferred further development of the inventive method, provisions are made so that the matrix material contains lithium aluminate originating from a pulsation reactor.

Advantageously, provisions are made so that the matrix material, used for the method, furthermore contains nano-scale secondary particles.

These nano-scale secondary particles preferably consists of one or more of ZrO₂, SiO₂, Al₂O₃ and TiO₂.

According to a preferred embodiment of the inventive method, the electrolyte matrix is incorporated in the “green” state in the molten carbonate fuel cell. As the fuel cell is being started up, the electrolyte matrix forms an aluminate, especially lithium aluminate, an oxide, especially zirconium dioxide and/or a zirconate, especially lithium zirconate.

Preferably, the conversion to lithium aluminate takes place by way of lithium carbonate, which is decomposed to lithium oxide at higher temperatures.

Preferably, zirconium carbide is furthermore converted to zirconium dioxide, and then, with lithium acetate, to lithium zirconate.

Preferably, the matrix material is synthesized during the firing up while the fuel cell is being started up for the first time, there being an increase in volume.

Furthermore, it is of advantage that the increase in volume of the matrix material while the fuel cell is being started up corresponds essentially to, or is larger than, the thermal expansion of fuel cell components associated with the electrolyte matrix.

Preferably, after the fuel cell has been started up, the electrolyte matrix has an open porosity of 30 to 70% and preferably of 40 to 60%.

Furthermore, it is of advantage if, after the fuel cell has been started up, the electrolyte matrix has an average pore diameter of less than 0.4 μm and preferably of less than 0.2 μm.

According to an alternative of the inventive method, the electrolyte matrix is produced as a single-layer matrix.

According to a different advantageous alternative of the method, the electrolyte matrix is produced as a multilayer matrix.

In a particularly advantageous manner, the inventive electrolyte matrix is produced as a multiplayer matrix with several similar layers.

In the following, an example of the invention is explained by means of the drawing.

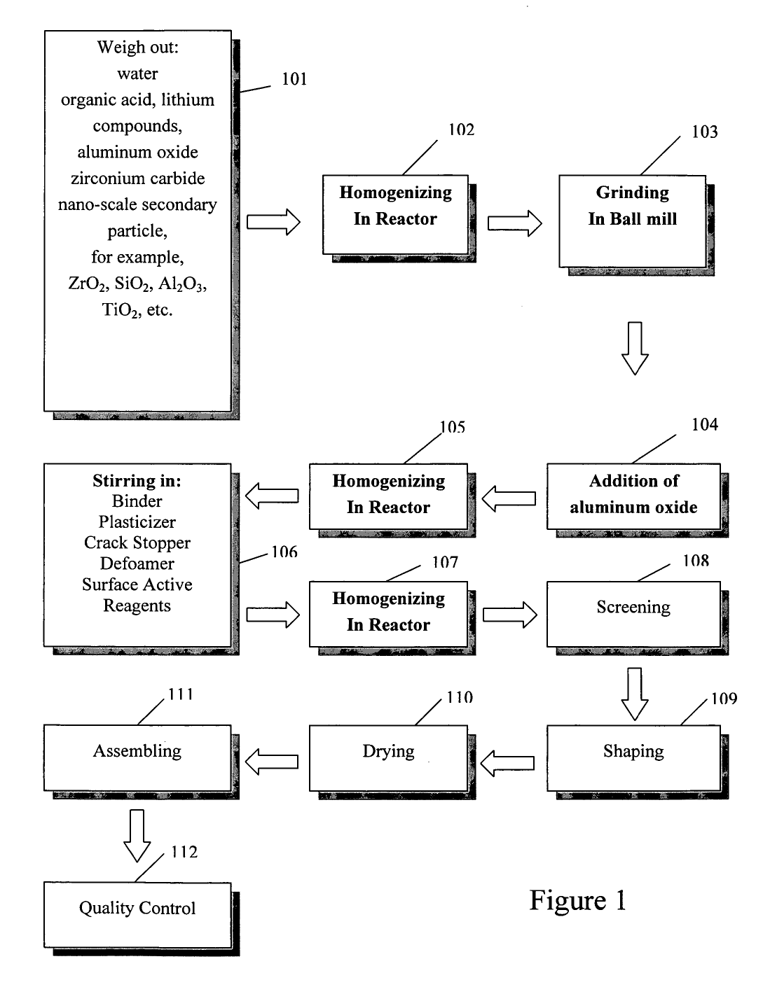

FIG. 1 shows a flow diagram of the production of an electrolyte matrix in accordance with an example of the invention.

In the method for producing an electrolyte matrix for a molten carbonate fuel cell, shown by the flow diagram in FIG. 1, initially, in step 101 of the method, the essential components of the matrix material are weighed out. These are one or more lithium compounds, such as lithium acetate and/or lithium carbonate and/or lithium aluminate, as well as aluminum oxide and one or more zirconium compounds, such as zirconium carbide, water and/or an organic acid, such as acetic acid. Surprisingly, it is possible to use water as dispersant and solvent in conjunction with these materials. This represents an appreciable cost advantage. Furthermore, nano-scale secondary particles such as ZrO₂, SiO₂, Al2O₃, TiO₂, etc., are added. In the following step 102 of the method, the mixture is homogenized in the reactor. After that, in step 103, the mixture is ground in a ball mill. After a further addition of aluminum oxide in step 104, the mixture is homogenized further in the reactor in step 105 of the process.

Into a ground and homogenized mixture of the above composition, additives and auxiliary materials are added and stirred in step 106 of the method, in order to ensure that the matrix material has the necessary mechanical and processing properties. Such additives and auxiliary materials, may, for example, comprise a binder, a plasticizing agent, a crack stopper, a defoamer, and/or surface-active reagents. After these auxiliary materials have been added, the mixture is homogenized once again in the reactor in step 107 of the method and then screened in step 108.

The raw, prepared matrix material for producing the electrolyte matrix is now molded, dried and assembled in steps 109, 110, and 111 of the method. Finally, the quality is controlled in step 112.

The result is an electrolyte matrix for a molten carbonate fuel cell, which comprises a matrix material, which undergoes an increase in volume when the fuel cell is started up, is relatively inexpensive to produce, ensures a high output of the fuel cell and makes prolongs the service life of the fuel cell. The costs of the matrix material and, with that, the costs of the fuel cell are clearly reduced. A low ohmic resistance and a high, open porosity are achieved.

1. An electrolyte matrix, especially for a molten carbonate fuel cell, wherein the electrolyte matrix consists of a matrix material, which experiences a volume increase when the fuel cell is being started up.

2. The electrolyte matrix of claim 1, wherein the matrix material contains one or more lithium compounds, aluminum oxide and one or more zirconium compounds.

3. The electrolyte material of claims 1 and 2, wherein the matrix material contains lithium acetate and/or lithium carbonate and/or lithium aluminate.

4. The electrolyte matrix of claims 1, 2, 3, wherein the matrix material contains zirconium carbide.

5. The electrolyte matrix of claims 1 to 4, wherein the matrix material furthermore contains a nano-scale secondary particle.

6. The matrix material of claim 5, wherein the matrix material contains one or more of Zr02, Si02, Al203 and/or Ti02 as nano-scale secondary particles.

7. The electrolyte matrix of claims 1 to 6, wherein, as the molten carbonate fuel cell is being started up, the matrix material forms an aluminate, especially lithium aluminate, an oxide, especially zirconium dioxide and/or a zirconate, especially lithium zirconate.

8. A method of one of the claims 1 to 7, wherein water is used, exclusively or not exclusively, as a dispersant and solvent for the preparation.

9. The electrolyte matrix of one of the claims 1 to 8, wherein, as the fuel cell is being started up, the matrix material synthesizes with an increase in volume.

10. The electrolyte matrix of claim 9, wherein the increase in volume of the matrix material, as the fuel cell is being started up, corresponds essentially to the thermal expansion of fuel cell components, associated with the electrolyte matrix, or is larger than this.

11. The electrolyte matrix of one of the claims 1 to 10, wherein the electrolyte matrix, after the fuel cell has been started up, has an open porosity of 30 to 70% and preferably of 40 to 60%.

12. The electrolyte matrix of one of the claims 1 to 11, wherein the electrolyte matrix, after the fuel cell has been started up, has an average pore diameter of less than 0.4 μm and preferably of less than 0.2 μm.

13. The electrolyte matrix of one of the claims 1 to 12, wherein the electrolyte matrix is produced as a single-layer matrix.

14. The electronic matrix of one of the claims 1 to 12, wherein the direct light matrix is produced as a multilayer matrix.

15. The electrolyte matrix of claim 14, wherein the electrolyte matrix is produced as a multilayer matrix with several similar layers.

16. A method for producing an electrolyte matrix, especially for a molten carbonate fuel cell, wherein the electrolyte matrix is produced from a matrix material, containing one or more lithium compounds, aluminum oxide and one or more zirconium compounds.

17. The method of claim 16, wherein the matrix material contains lithium acetate and/or lithium carbonate and/or lithium aluminate.

18. The method of claims 16 or 17, wherein the matrix material contains zirconium carbide.

19. The method of one of the claims 16, 17 or 18, wherein the matrix material contains lithium aluminate, which has originated from a pulsation reactor.

20. The method of one of the claims 16 to 19, wherein the matrix material contains nano-scale secondary particles.

21. The method of one of the claims 16 to 20, wherein the matrix material contains Zr02, SiO2, Al2O3 and/or TiO2 as nano-scale secondary particles.

22. The method of one of the claims 16 to 21, wherein water is used exclusively or not exclusively as dispersant and solvent for the production.

23. The method of one of the claims 16 to 22, wherein the electrolyte matrix is incorporated in the “green” state into the molten carbonate fuel cell and, during the firing while the fuel cell is being started up, forms an aluminate, especially lithium aluminate, an oxide, especially zirconium dioxide and/or a zirconate, especially lithium zirconate.

24. The method of claim 23, wherein the conversion to lithium aluminate takes place over lithium carbonate, which is decomposed at higher temperatures to lithium oxide.

25. The method of claims 23 or 24, wherein zirconium carbide is converted to zirconium dioxide, which is then converted to lithium zirconate with lithium acetate.

26. The method of one of the claims 16 to 25, wherein, as the fuel cell is being started up, the matrix material synthesizes with an increase in volume.

27. The method of claim 26, wherein, as the fuel cell is being started up, the increase in volume of the matrix material corresponds essentially to the thermal expansion of fuel cell components associated with the electrolyte matrix or is larger than this expansion.

28. The method of one of the claims 16 to 27, wherein the electrolyte matrix, after the fuel cell has been started up, has an open porosity of 30 to 70% and preferably of 40 to 60%.

29. The method of one of the claims 16 to 28, wherein, after the fuel cell has been started up, the electrolyte matrix has an average pore diameter of less than 0.4 μm and preferably of less than 0.2 μm.

30. The method of one of the claims 16 to 29, wherein the electrolyte matrix is produced as a single-layer matrix.

31. The method of one of the claims 16 to 29, wherein the electrolyte matrix is produced as a multilayer matrix.

32. The method of claim 31, wherein the electrolyte matrix is produced as a multilayer matrix with several similar layers.
